(19) United States
(12) Patent Application Publication
(10) Pub. No.: US 2026/0213610 A1
(43) Pub. Date: Jul. 23, 2026

(54) VEHICLE DRIVING APPARATUS

(71) Applicant: SUBARU CORPORATION, Tokyo (JP)

(72) Inventor: Kenta WATANABE, Tokyo (JP)

(21) Appl. No.: 19/444,672

(22) Filed: Jan. 9, 2026

(30) Foreign Application Priority Data
Jan. 23, 2025 (JP) 2025-010136

(51) Int. Cl. H02K 7/00; H02K 5/04; H02K 7/08

(52) U.S. Cl. CPC H02K 7/003; H02K 5/04; H02K 7/08

(57) ABSTRACT

A vehicle driving apparatus including an electric motor, a housing, a hollow shaft, a bearing, a conductive plate, a brush holder, and a conductive brush. The conductive plate is disposed on a rotation center line of the hollow shaft. The brush holder is disposed on the rotation center line. The conductive brush is attached to the brush holder and is in contact with the conductive plate. The hollow shaft has an oil discharge hole that extends radially through the hollow shaft. When an upstream reference plane is an imaginary plane that is orthogonal to the rotation center line and in contact with the oil discharge hole at an upstream side of the oil discharge hole, a contact surface between the conductive plate and the conductive brush is disposed at a position on the upstream reference plane or a position on a downstream side of the upstream reference plane.

### CROSS-REFERENCE TO RELATED APPLICATIONS

The present application claims priority from Japanese Patent Application No. 2025-010136 filed on January 23, 2025, the entire contents of which are hereby incorporated by reference.

### BACKGROUND

The disclosure relates to a vehicle driving apparatus.

A vehicle, such as an electric automobile, includes a vehicle driving apparatus, such as an electric axle including an electric motor. The vehicle driving apparatus includes a housing that is electrically coupled to a stator of the electric motor, and a rotating shaft that is electrically coupled to a rotor of the electric motor. The rotating shaft of the vehicle driving apparatus is supported on the housing by a bearing (see Japanese Unexamined Patent Application Publication No. 2023-147277, Japanese Patent No. 6437993, and Japanese Patent No. 5402619).

### SUMMARY

An aspect of the disclosure provides a vehicle driving apparatus including an electric motor, a housing, a hollow shaft, a bearing, a conductive plate, a brush holder, and a conductive brush. The housing is configured to be electrically coupled to a stator of the electric motor and has an oil flow path that communicates with an oil supply source. The hollow shaft is configured to be electrically coupled to a rotor of the electric motor and has an internal flow path that communicates with the oil flow path. The bearing includes a first race attached to the housing and a second race attached to the hollow shaft. The conductive plate is attached to the internal flow path in the hollow shaft and disposed on a rotation center line of the hollow shaft. The brush holder is disposed on the rotation center line of the hollow shaft and has a proximal end attached to the housing and a distal end disposed in the internal flow path. The conductive brush is attached to the brush holder. The conductive brush projects from the distal end and is in contact with the conductive plate. The hollow shaft has an oil discharge hole that extends radially through the hollow shaft and that communicates with the internal flow path. When an upstream reference plane is an imaginary plane that is orthogonal to the rotation center line of the hollow shaft and in contact with the oil discharge hole at an upstream side of the oil discharge hole, a contact surface between the conductive plate and the conductive brush is disposed at a position on the upstream reference plane or a position on a downstream side of the upstream reference plane.

### BRIEF DESCRIPTION OF THE DRAWINGS

FIG. 1 illustrates an example of a vehicle;

FIG. 2 illustrates a vehicle driving apparatus according to an embodiment of the disclosure;

FIG. 3 illustrates a bearing and a region around the bearing;

FIG. 4 illustrates the manner in which oil is supplied to a hollow shaft;

FIG. 5 illustrates a brush unit and a region around the brush unit according to another example; and

FIG. 6 illustrates a brush unit and a region around the brush unit according to another example.

### DETAILED DESCRIPTION

An electric motor includes a stator and a rotor having a potential difference therebetween , and this may cause electrical erosion of a bearing that supports the rotating shaft. Since electrical erosion is one of the causes of damage to raceway surfaces of the bearing, it is desirable to suppress electrical erosion of the bearing.

An embodiment of the disclosure will now be described in detail with reference to the drawings. In the following description, identical or substantially identical structures and elements are denoted by the same reference signs, and redundant description thereof will be omitted.

### Electric Axle

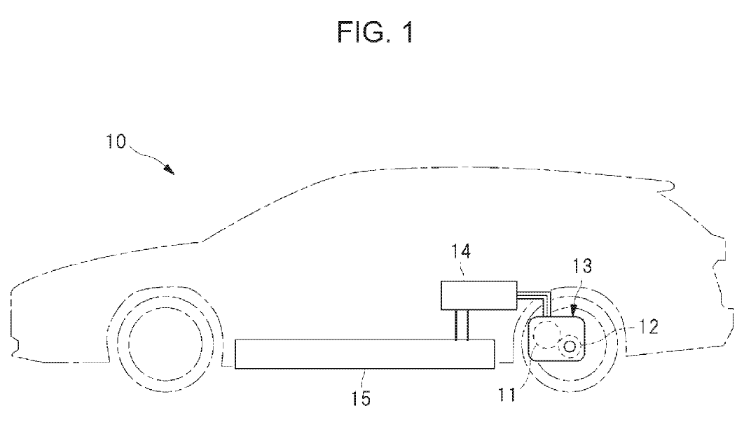

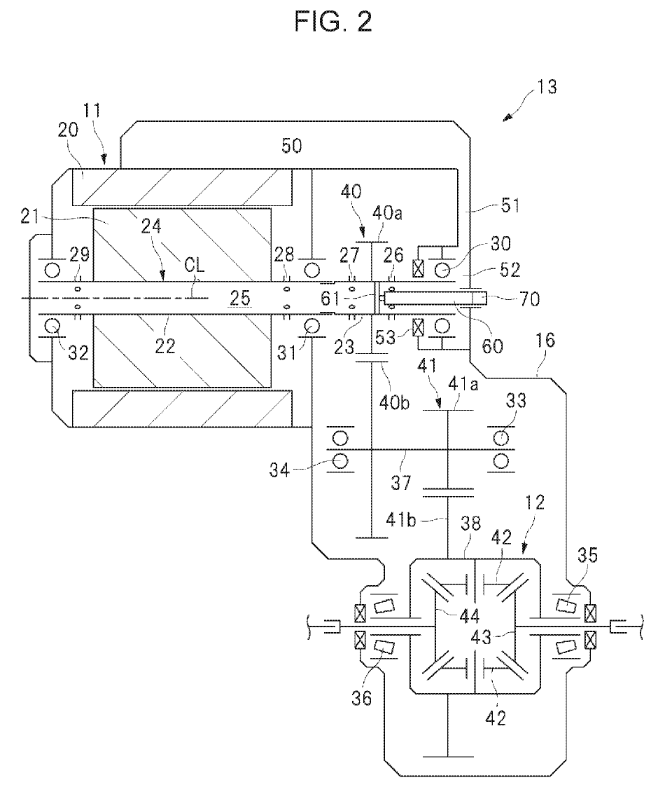

FIG. 1 illustrates an example of a vehicle 10. FIG. 2 illustrates a vehicle driving apparatus according to an embodiment of the disclosure. As illustrated in FIG. 1, the vehicle 10 includes an electric axle (vehicle driving apparatus) 13 and a battery pack 15. The electric axle 13 includes an electric motor 11 and a differential mechanism 12. The battery pack 15 is coupled to the electric motor 11 through an inverter 14. As illustrated in FIG. 2, the electric axle 13, or a vehicle driving apparatus, includes a housing 16 that defines an outer shell, the electric motor 11 disposed in the housing 16, and the differential mechanism 12 disposed in the housing 16.

The electric motor 11 includes a stator 20 attached to the housing 16 and a rotor 21 disposed radially inward relative to the stator 20. A hollow motor shaft 22 is attached to the rotor 21. A hollow gear shaft 23 is coupled to the motor shaft 22. The motor shaft 22 and the gear shaft 23 are coupled to each other to form a single hollow shaft 24. The hollow shaft 24 has an internal flow path 25 extending in an axial direction along a rotation center line CL, and oil discharge holes 26, 27, 28, and 29 that extend radially through the hollow shaft 24 and communicate with the internal flow path 25. The hollow shaft 24 is rotatably supported on the housing 16 by bearings 30, 31, and 32.

The housing 16 houses an intermediate shaft 37 disposed parallel to the hollow shaft 24 and a differential case 38 disposed parallel to the intermediate shaft 37. The intermediate shaft 37 is rotatably supported on the housing 16 by bearings 33 and 34. The differential case 38 is rotatably supported on the housing 16 by bearings 35 and 36.

A driving gear 40a is provided on the hollow shaft 24, and a driven gear 40b is provided on the intermediate shaft 37. The driving gear 40aand the driven gear 40b mesh with each other to form a speed-reduction gear train 40. A driving gear 41ais provided on the intermediate shaft 37, and a driven gear 41b is provided on the differential case 38. The driving gear 41a and the driven gear 41b mesh with each other to form a speed-reduction gear train 41. Thus, the rotor 21 of the electric motor 11 is coupled to the differential case 38 through the speed-reduction gear trains 40 and 41. Pinions 42 and side gears 43 and 44 that mesh with one another are assembled in the differential case 38 of the differential mechanism 12.

The housing 16 has a reservoir chamber 50 that stores oil moved upward by the speed-reduction gear trains 40 and 41 and an oil flow path 51 that communicates with the reservoir chamber (oil supply source) 50. The oil flow path 51 opens in a communication chamber 52 disposed near the bearing 30 that supports an end of the hollow shaft 24. As described below, the internal flow path 25 in the hollow shaft 24 communicates with a downstream end of the oil flow path 51 in the housing 16, and oil is supplied from the oil flow path 51 to the oil discharge holes 26 to 29 through the internal flow path 25. The oil discharged through the oil discharge holes 26 to 29 in the hollow shaft 24 is used to lubricate the speed-reduction gear trains 40 and 41 and cool the electric motor 11. To seal the communication chamber 52 that communicates with the oil flow path 51 and the internal flow path 25, an oil seal 53 is attached between the hollow shaft 24 and the housing 16.

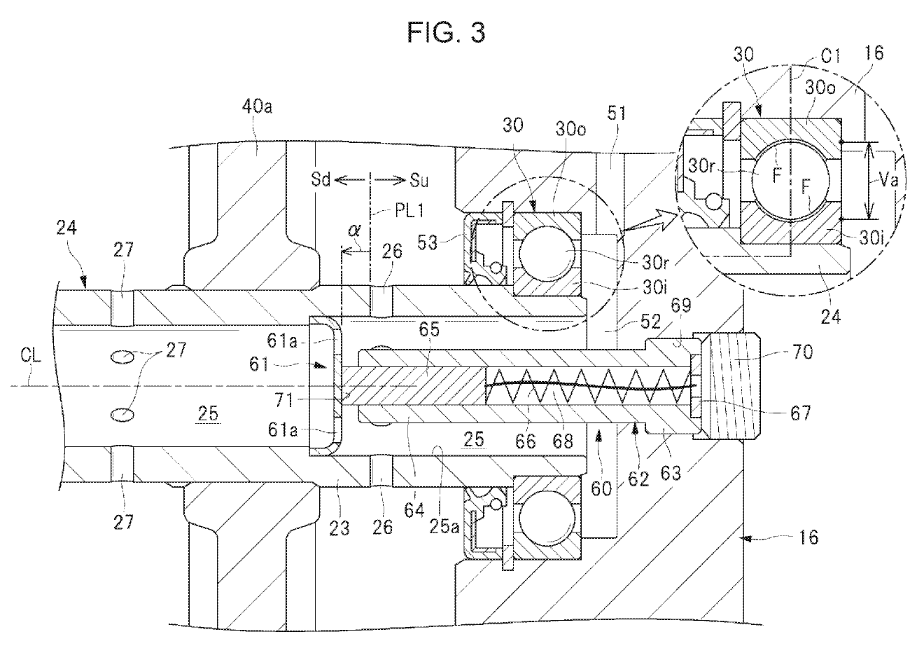

FIG. 3 illustrates the bearing 30 and a region around the bearing 30. As illustrated in FIG. 3, the bearing 30 that supports the hollow shaft 24 includes an outer ring (first race) 30o attached to the housing 16, an inner ring (second race) 30i attached to the hollow shaft 24, and rollers 30r provided between the outer ring 30o and the inner ring 30i. The housing 16 is made of a metal material, such as an aluminum alloy. The hollow shaft 24 is made of a metal material, such as carbon steel or stainless steel. The outer ring 30o, the inner ring 30i, and the rollers 30r of the bearing 30 are made of a metal material, such as carbon steel or stainless steel. Thus, the outer ring 30o of the bearing 30 is electrically coupled to the stator 20 of the electric motor 11 through the housing 16. The inner ring 30i of the bearing 30 is electrically coupled to the rotor 21 of the electric motor 11 through the hollow shaft 24.

As described above, the outer ring 30o is electrically coupled to the stator 20, and the inner ring 30i is electrically coupled to the rotor 21. Accordingly, as illustrated in an enlarged part in FIG. 3, the electric motor 11 applies a shaft voltage Va across the outer ring 30o and the inner ring 30i of the bearing 30. When the shaft voltage Va exceeds a withstand voltage of the bearing 30, a current flows along a current path C1 represented by the one-dot chain line, causing a spark that leads to electrical erosion of the outer ring 30o, the inner ring 30i, and other elements. The withstand voltage of the bearing 30 corresponds to a breakdown voltage of a lubricating oil film F formed in the bearing 30. The potential difference Va across the outer ring 30o and the inner ring 30i, which causes electrical erosion, may be generated due to inverter driving of the electric motor 11.

### Brush Unit

Since the electrical erosion causes damage to, for example, the raceway surfaces of the bearing 30, it is desirable to prevent or reduce the occurrence of electrical erosion. Accordingly, a brush unit 60 is provided between the hollow shaft 24 and the housing 16 to reduce the potential difference. As illustrated in FIG. 3, a conductive plate 61 is attached to the internal flow path 25 of the hollow shaft 24, and the brush unit 60, which is in contact with the conductive plate 61, is attached to the housing 16. The brush unit 60 includes a brush holder 62 disposed on the rotation center line CL of the hollow shaft 24. The brush holder 62 has a proximal end 63 attached to the housing 16 and a distal end 64 disposed in the internal flow path 25. The conductive plate 61 has through holes 61a for allowing oil to flow therethrough from an upstream side to a downstream side.

The brush unit 60 includes a conductive brush 65 attached to the distal end 64 of the brush holder 62, a spring 66 that urges the conductive brush 65 toward the conductive plate 61, and a conductive washer 67 attached to the proximal end 63 of the brush holder 62. The conductive brush 65 projects from the distal end 64 of the brush holder 62 and is in contact with the conductive plate 61. The conductive brush 65 and the conductive washer 67 are electrically coupled to each other by a conductive wire 68. The housing 16 has a brush attachment hole 69 in which the brush holder 62 is inserted and to which a plug 70 is fitted. The plug 70 is in contact with the conductive washer 67 at the proximal end 63. The conductive brush 65 is made of a conductive material, such as graphite. The conductive plate 61, the brush holder 62, the conductive washer 67, and the plug 70 are made of a metal material, such as carbon steel or stainless steel.

The brush unit 60 provided in the electric axle 13 enables a current to flow between the housing 16 and the hollow shaft 24 through the brush unit 60. Accordingly, the potential difference between the housing 16 and the hollow shaft 24 can be reduced. In other words, the potential difference between the outer ring 30o and the inner ring 30i can be reduced, so that the occurrence of electrical erosion in the bearing 30 can be prevented or reduced. The bearings 30 to 36 attached to the housing 16 all have their outer rings electrically coupled to each other through the housing 16 and their inner rings electrically coupled to each other through rotating bodies, such as shafts and gears. Thus, electrical erosion in the bearings 30 to 36 attached to the housing 16 can be prevented or reduced by mounting the brush unit 60 in the electric axle 13.

### State of Contact Between Conductive Plate and Conductive Brush

To prevent or reduce electrical erosion by using the brush unit 60, the conductive brush 65 is to be appropriately brought into contact with the conductive plate 61. Since a contact surface 71 between the conductive plate 61 and the conductive brush 65 is disposed in the internal flow path 25 through which the oil flows, the contact surface 71 is to be separated from the oil to ensure sufficient conductivity of the contact surface 71. Accordingly, as illustrated in FIG. 3, the contact surface 71 between the conductive plate 61 and the conductive brush 65 is disposed on a downstream side Sd of the oil discharge hole 26. For example , assume that a downstream reference plane PL1 is an imaginary plane that is orthogonal to the rotation center line CL of the hollow shaft 24 and that is in contact with the oil discharge holes 26 at the downstream side Sd of the oil discharge holes 26. Here, as indicated by arrow α, the contact surface 71 between the conductive plate 61 and the conductive brush 65 is disposed at a position on the downstream side Sd of the downstream reference plane PL1.

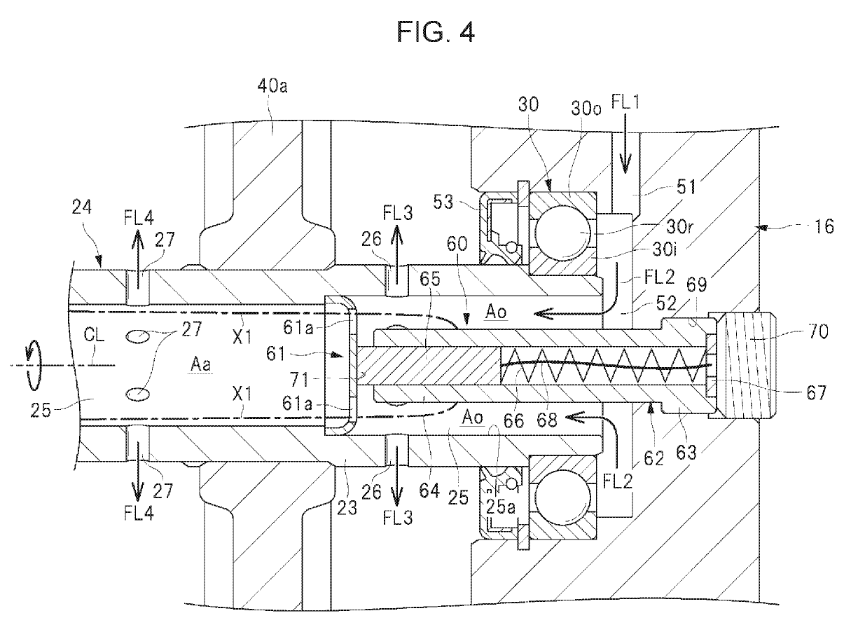

FIG. 4 illustrates the manner in which oil is supplied to the hollow shaft 24. As indicated by arrows FL1 and FL2 in FIG. 4, the oil that has flowed into the communication chamber 52 from the oil flow path 51 in the housing 16 enters the internal flow path 25 in the hollow shaft 24 from the communication chamber 52. While the vehicle is moving, the hollow shaft 24 rotates so that, as indicated by arrows FL3 and FL4, the oil flowing through the internal flow path 25 is discharged through the oil discharge holes 26 and 27 due to centrifugal force. Since the oil flowing through the internal flow path 25 receives centrifugal force, the oil moves radially outward toward an inner wall surface 25a in the internal flow path 25. The oil that has flowed into the hollow shaft 24 flows from the upstream side toward the downstream side and is discharged out of the shaft through the oil discharge holes 26 to 29. Accordingly, the amount of oil in the internal flow path 25 of the hollow shaft 24 gradually decreases from the upstream side toward the downstream side of the internal flow path 25.

Since the amount of oil gradually decreases from the upstream side toward the downstream side of the internal flow path 25 as described above, the internal flow path 25 has an oil region Ao and an air region Aa divided from each other by a boundary line X1. The air region Aa, which is free of oil, is in a radially central region of the internal flow path 25. The oil region Ao, in which oil is present, is in a radially outer region in the internal flow path 25. The oil flowing through the internal flow path 25 starts to be discharged out of the shaft from the oil discharge holes 26 at the upstream side. Thus, the air region Aa starts to appear at a location close to and upstream of the oil discharge hole 26.

In the example illustrated in FIG. 3, the contact surface 71 between the conductive plate 61 and the conductive brush 65 is disposed on the downstream side of the downstream reference plane PL1. Accordingly, the contact surface 71 between the conductive plate 61 and the conductive brush 65 can be disposed in the air region Aa. Thus, the contact surface 71 can be separated from the oil to ensure sufficient conductivity of the contact surface 71, so that the grounding performance of the brush unit 60 can be increased to suppress electrical erosion of the bearing 30. The contact surface 71 between the conductive plate 61 and the conductive brush 65 intersects the rotation center line CL of the hollow shaft 24. Thus, the relative speed between the conductive plate 61 that rotates and the conductive brush 65 that is stationary can be reduced, so that wear of the conductive brush 65 can be reduced.

In the example illustrated in FIG. 3, the contact surface 71 between the conductive plate 61 and the conductive brush 65 is disposed on the downstream side of the downstream reference plane PL1. However, the arrangement is not limited to this, and the contact surface 71 between the conductive plate 61 and the conductive brush 65 may be disposed on the downstream reference plane PL1. Also when the contact surface 71 is disposed on the downstream reference plane PL1, the contact surface 71 can be disposed in the air region Aa so that the contact surface 71 is separated from the oil to ensure sufficient conductivity of the contact surface 71. The boundary line X1 between the oil region Ao and the air region Aa varies depending on the amount of oil supplied to the internal flow path 25 and the rotational speed of the hollow shaft 24.

### First Modification

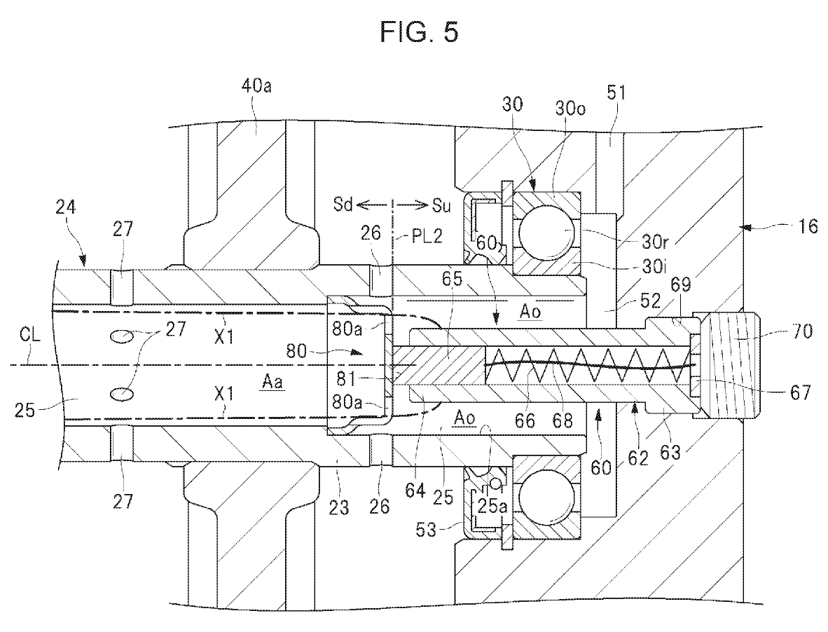

Although the contact surface 71 between the conductive plate 61 and the conductive brush 65 is disposed at a position on the downstream side of the downstream reference plane PL1 in the example illustrated in FIG. 3, the arrangement is not limited to this. FIG. 5 illustrates the brush unit 60 and a region around the brush unit 60 according to another example.

Referring to FIG. 5, a conductive plate 80 having through holes 80a is attached to the internal flow path 25 in the hollow shaft 24. The brush unit 60 including the conductive brush 65 in contact with the conductive plate 80 is attached to the brush attachment hole 69 in the housing 16. A contact surface 81 between the conductive plate 80 and the conductive brush 65 is disposed on an upstream reference plane PL2 that is in contact with the oil discharge holes 26 at an upstream side Su of the oil discharge holes 26. The upstream reference plane PL2 is an imaginary plane that is orthogonal to the rotation center line CL of the hollow shaft 24 and that is in contact with the oil discharge holes 26 at the upstream side Su of the oil discharge holes 26.

When the contact surface 81 is disposed on the upstream reference plane PL2, the contact surface 81 can be disposed in the air region Aa. Thus, the contact surface 81 can be separated from the oil to ensure sufficient conductivity of the contact surface 81, so that the grounding performance of the brush unit 60 can be increased to suppress electrical erosion of the bearing 30. In the example illustrated in FIG. 5, the contact surface 81 is disposed on the upstream reference plane PL2. However, the arrangement is not limited to this, and the contact surface 81 may be disposed on the downstream side Sd of the upstream reference plane PL2. Also when the contact surface 81 is disposed on the downstream side Sd of the upstream reference plane PL2, the contact surface 81 can be disposed in the air region Aa.

### Second Modification

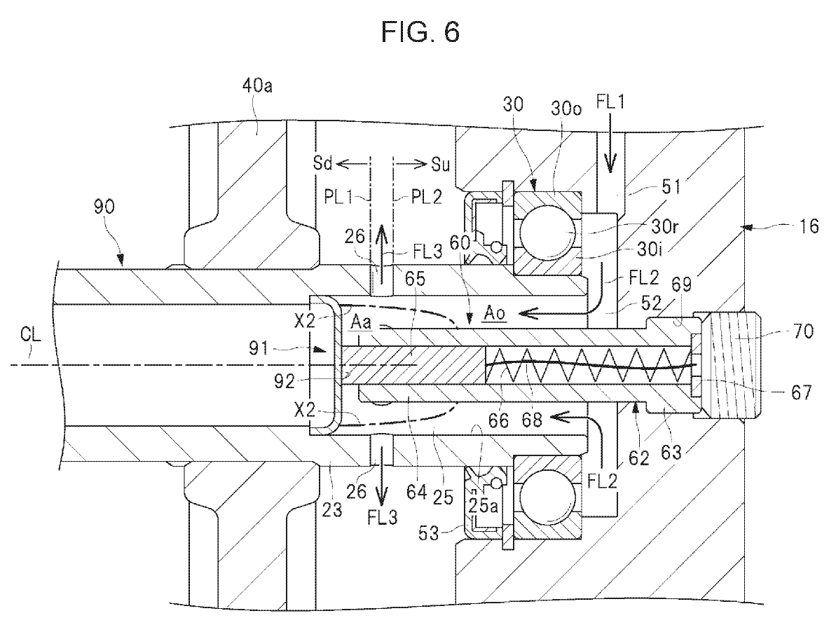

In the examples illustrated in FIGS. 3 and 5, the conductive plates 61 and 80 have the through holes 61a and 80a, respectively. However, the conductive plates 61 and 80 are not limited to this, and the through holes 61a and 80a may be omitted. FIG. 6 illustrates the brush unit 60 and a region around the brush unit 60 according to another example.

Referring to FIG. 6, a conductive plate 91 having no through holes is attached to the internal flow path 25 in a hollow shaft 90. Since the conductive plate 91 blocks the oil, the hollow shaft 90 simply has the oil discharge holes 26 on the upstream side Su of the conductive plate 91. The brush unit 60 including the conductive brush 65 in contact with the conductive plate 91 is attached to the brush attachment hole 69 in the housing 16. A contact surface 92 between the conductive plate 91 and the conductive brush 65 is disposed at a position on the downstream side Sd of the downstream reference plane PL1.

Also when the conductive plate 91 has no through holes, the contact surface 92 between the conductive plate 91 and the conductive brush 65 can be disposed in the air region Aa by positioning the contact surface 92 on the downstream side of the downstream reference plane PL1. Thus, the contact surface 92 can be separated from the oil to ensure sufficient conductivity of the contact surface 92, so that the grounding performance of the brush unit 60 can be increased to suppress electrical erosion of the bearing 30. The oil region Ao and the air region Aa have a boundary line X2 that varies depending on the amount of oil supplied to the internal flow path 25 and the rotational speed of the hollow shaft 90.

In the example illustrated in FIG. 6, similarly to the example illustrated in FIG. 3, the contact surface 92 is disposed on the downstream side Sd of the downstream reference plane PL1. However, the arrangement is not limited to this. For example, the contact surface 92 may be disposed on the downstream reference plane PL1. Alternatively, the contact surface 92 may be disposed on the upstream reference plane PL2, or be disposed on the downstream side Sd of the upstream reference plane PL2.

### Other Modifications

The disclosure is not limited to the above-described embodiment and may be modified in various ways without departing from the gist of the disclosure. Although the electric axle 13 is described above as an example of a vehicle driving apparatus of the disclosure, the vehicle driving apparatus is not limited to this. For example, the vehicle driving apparatus may be a power unit for a hybrid vehicle including an engine and an electric motor, and the technology of the disclosure may be applied to the power unit. In addition, in the above description, the reservoir chamber 50 that causes oil to fall by gravity is described as an example of an oil supply source that communicates with the oil flow path 51. However, the oil supply source is not limited to this. For example, an oil pump that discharges oil may be used as the oil supply source that communicates with the oil flow path 51.

Although the outer ring 30o is attached to the housing 16 and the inner ring 30i is attached to each of the hollow shafts 24 and 90, the arrangement is not limited to this. The inner ring 30i may be attached to the housing 16, and the outer ring 30o may be attached to each of the hollow shafts 24 and 90. In this case, the inner ring 30i serves as a first race, and the outer ring 30o serves as a second race. In the illustrated example, the hollow shafts 24 and 90 have multiple oil discharge holes 26 arranged at predetermined intervals in the circumferential direction. However, the hollow shafts 24 and 90 are not limited to this, and may have one oil discharge hole 26. Additionally, although the illustrated oil discharge holes 26 have a circular shape in cross section, the oil discharge holes may have other shapes in cross section.

According to the disclosure, electrical erosion of the bearing can be reduced.

1. A vehicle driving apparatus comprising:
an electric motor;
a housing configured to be electrically coupled to a stator of the electric motor and having an oil flow path that communicates with an oil supply source;
a hollow shaft configured to be electrically coupled to a rotor of the electric motor and having an internal flow path that communicates with the oil flow path;
a bearing comprising a first race attached to the housing and a second race attached to the hollow shaft;
a conductive plate attached to the internal flow path in the hollow shaft and disposed on a rotation center line of the hollow shaft;
a brush holder disposed on the rotation center line of the hollow shaft and having a proximal end attached to the housing and a distal end disposed in the internal flow path; and
a conductive brush attached to the brush holder, the conductive brush projecting from the distal end and being in contact with the conductive plate,
wherein the hollow shaft has an oil discharge hole that extends radially through the hollow shaft and that communicates with the internal flow path, and
wherein, when an upstream reference plane is an imaginary plane that is orthogonal to the rotation center line of the hollow shaft and in contact with the oil discharge hole at an upstream side of the oil discharge hole, a contact surface between the conductive plate and the conductive brush is disposed at a position on the upstream reference plane or a position on a downstream side of the upstream reference plane.

2. The vehicle driving apparatus according to claim 1,
wherein the contact surface between the conductive plate and the conductive brush intersects the rotation center line of the hollow shaft.

3. The vehicle driving apparatus according to claim 1,
wherein, when a downstream reference plane is an imaginary plane that is orthogonal to the rotation center line of the hollow shaft and in contact with the oil discharge hole at a downstream side of the oil discharge hole, the contact surface between the conductive plate and the conductive brush is disposed at a position on the downstream reference plane or a position on the downstream side of the downstream reference plane.

4. The vehicle driving apparatus according to claim 1,
wherein the conductive plate has a through hole.

5. The vehicle driving apparatus according to claim 1,
wherein the first race is an outer ring, and
wherein the second race is an inner ring.
